(19) United States
(12) Patent Application Publication
(10) Pub. No.: US 2009/0182533 A1
(43) Pub. Date: Jul. 16, 2009

(54) REMOTE DIAGNOSTIC SERVICE

(75) Inventors: Erik Neuenschwander, San Mateo, CA (US); Eric Albert, Mountain View, CA (US); Lyle Seplowitz, Mountain View, CA (US)

Correspondence Address: FISH & RICHARDSON P.C., PO BOX 1022, MINNEAPOLIS, MN, 55440-1022, US

(73) Assignee: Apple Inc.

(21) Appl. No.: 12/014,048

(22) Filed: Jan. 14, 2008

(51) Int. Cl. G06F 11/00; H04B 17/00; G06F 11/30

(52) U.S. Cl. 702/185; 702/188; 455/67.11

(57) ABSTRACT

Diagnostic events can be collected on electronic devices at geographically distributed service centers and transmitted to a remote (e.g., network-based) diagnostic service. The diagnostic service can aggregate and analyze the diagnostic events to determine, for example, one or more possible causes of the diagnostic events, and can provide information or guidance to users and/or service personnel for characterizing, resolving or explaining the diagnostic events. In one aspect, log files of diagnostic events captured on devices are sent to the diagnostic service. For each log file, the diagnostic service can compute frequencies of recorded diagnostic events. The computed frequencies can be compared against accepted and/or expected values generated from reference data. The diagnostic service can respond to users and/or service personnel with information or guidance for resolving, characterizing or explaining the diagnostic event based on a result of the comparisons.

### TECHNICAL FIELD

This subject matter is generally related to software diagnostics.

### BACKGROUND

Service center personnel are charged with resolving customer issues regarding software installed on devices, such as personal computers, mobile phones and media players. One example of a service center is the “Genius Bar” found in retail outlets operated by Apple Inc. As modern devices become more complex, service personnel find it increasingly difficult to diagnose technical problems and resolve customer issues. For example, service personnel may have difficulty in differentiating between problems unique to a particular device or customer and generic problems with the device.

### SUMMARY

Diagnostic events can be collected on electronic devices at geographically distributed service centers and transmitted to a remote (e.g., network-based) diagnostic service. The diagnostic service can aggregate and analyze the diagnostic events to determine one or more possible causes of the diagnostic events, and can provide information or guidance to users and/or service personnel for characterizing, resolving and/or explaining the diagnostic events. In one aspect, log files of diagnostic events captured on devices are sent to the diagnostic service. For each log file, the diagnostic service can compute frequencies of recorded diagnostic events. The computed frequencies can be compared against accepted and/or expected values generated from reference data (e.g., field data, trend data). The diagnostic service can respond to users and/or service personnel with information or guidance for characterizing, resolving or explaining the diagnostic event(s) based on results of the comparisons.

The disclosed implementations provide reliable historical data about software or hardware behavior on a device and provide information and/or guidance to service personnel to rapidly resolve or explain customer issues. The information or guidance is updated (e.g., continuously, automatically) so that the information or guidance reflects the most current reference data associated with diagnostic events.

Other implementations are disclosed which are directed to systems, methods, devices and computer-readable media.

### DESCRIPTION OF DRAWINGS

FIG. 1 is a block diagram of an example diagnostic system with a remote diagnostic service.

FIG. 2 is a flow diagram of an example process for sending diagnostic event files to the remote diagnostic service of FIG. 1

FIG. 3 is a flow diagram of an example process for analyzing diagnostic events and providing information or guidance to users or service center personnel based on a result of the analysis.

FIG. 4 is a schematic diagram of an example device for collecting diagnostic event files for use in the diagnostic system of FIG. 1.

### DETAILED DESCRIPTION

### System Overview

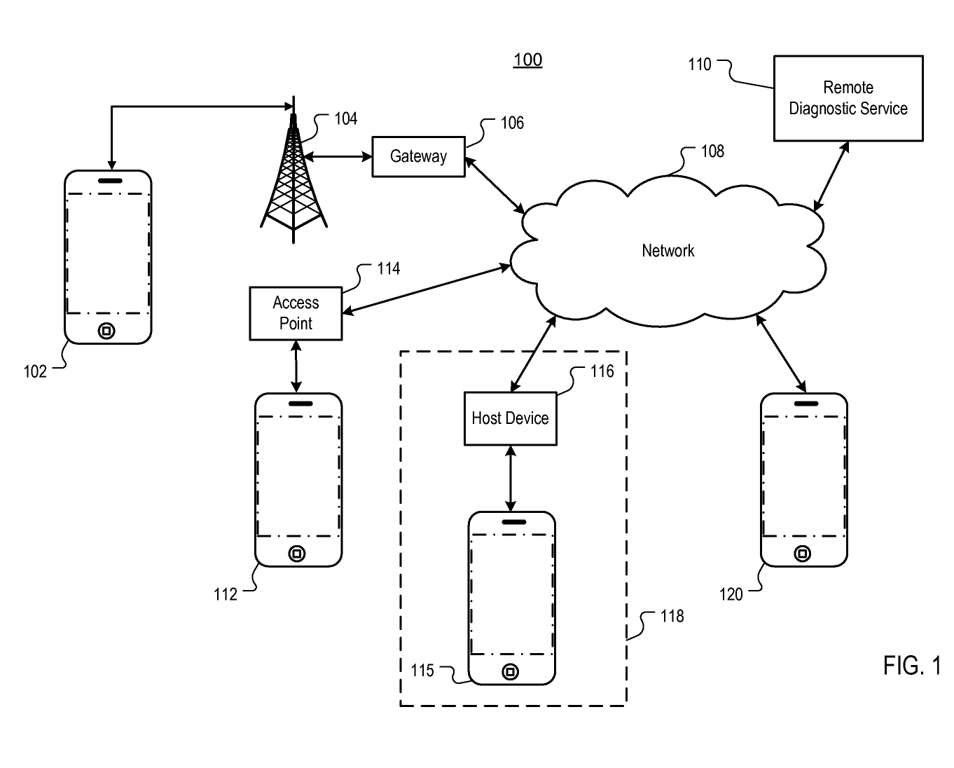

FIG. 1 is a block diagram of example diagnostic system 100 with remote diagnostic service 110. In some implementations, system 100 can include devices 102, 112, 115, 120, one or more service centers 118 and remote (e.g., network-based) diagnostic service 110. The devices can be coupled to network 108 (e.g., the Internet, WLAN) using a variety of connectivity technologies. For example, device 102 (e.g., a cellular phone) can couple to network 108 through cell tower 104 and gateway 106. Device 112 can couple to network 108 through wireless access point 114 (e.g., Wi-Fi). Device 115 can couple to network 108 through host device 116 (e.g., a personal computer). Device 120 can couple directly to network 108 using, for example, Ethernet, telephone lines, cable modem, wireless link, etc. Once connected, devices 102, 112, 115, 120 can communicate with remote diagnostic service 110, or host devices (e.g., host device 116) can communicate with remote diagnostic service 110 on behalf of coupled device(s). Some examples of devices include but are not limited to: personal computers, mobile phones, smart phones, media players, email devices, electronic devices, game devices, tablets, ebook readers, thumbdrives, etc. Remote diagnostic service 110 can be a service provider which operates one or more server computers for communicating with devices. Service centers can be any facility where a user can receive technical assistance for a device. An example service center is the “Genius Bar” found in retail stores operated by Apple Inc. (Cupertino, Calif.).

### Example Device Process

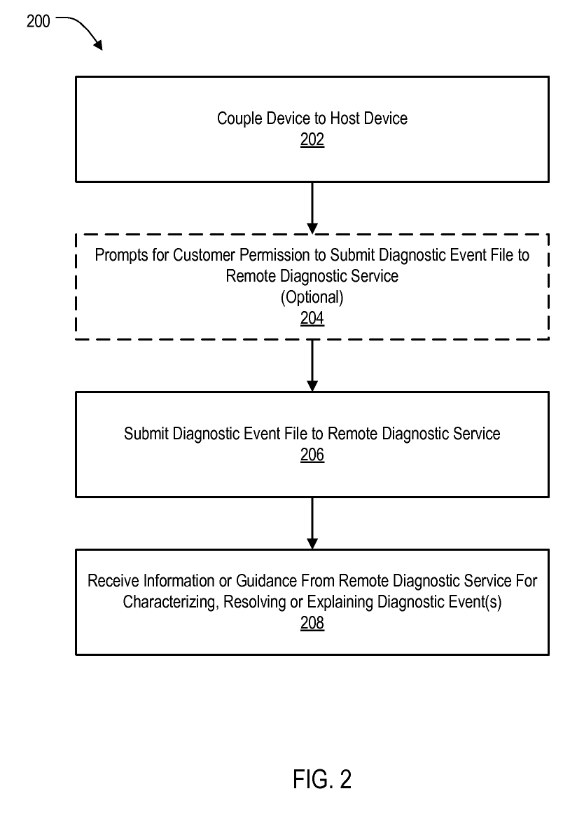

FIG. 2 is a flow diagram of example process 200 for sending diagnostic event logs to the remote diagnostic service 110. Process 200 is described below in reference to device 115 and host device 116 of FIG. 1.

In some implementations, process 200 can begin when a device is coupled (e.g., a wireless or physical connection) to a host device (202). The host device can be any device capable of connecting to a network, including but not limited to: a personal computer, another device, a router, a hub, etc. In the present example, the host device can be a service center computer located in a service center, such as an Apple “Genius Bar.” The device can be wirelessly coupled or physically tethered to the service center computer using a wireless transceiver, cable or dock. Optionally, a diagnostic application running on the host device prompts for customer permission to obtain diagnostic event data from the device (204). Optionally, other data may be gathered (e.g., data related to the diagnostic events or the submission of those events). If the customer accepts, a diagnostic event file (e.g., a historical event log) can be retrieved from the device and submitted, along with any additional data, to the remote diagnostic service (206) for analysis. The event data can be submitted using known Web technologies for establishing and maintaining communication links between two devices (e.g., HTTP, TCP/IP, SSL, HTML, XML, Java). The remote diagnostic service responds by providing information or guidance (e.g., instructions) to the host device or the coupled device which can be reviewed by service personnel using a graphical user interface of the diagnostic application (208).

In other implementations, a device can be coupled directly to a network and the remote diagnostic service without coupling to a host device. In such implementations, the device can join a local network (e.g., Wi-Fi) and gain access to the remote diagnostic service through the local network. The user can receive information or guidance on their device to allow the user to resolve diagnostic event(s) without the assistance of service personnel.

### Example Diagnostic Service

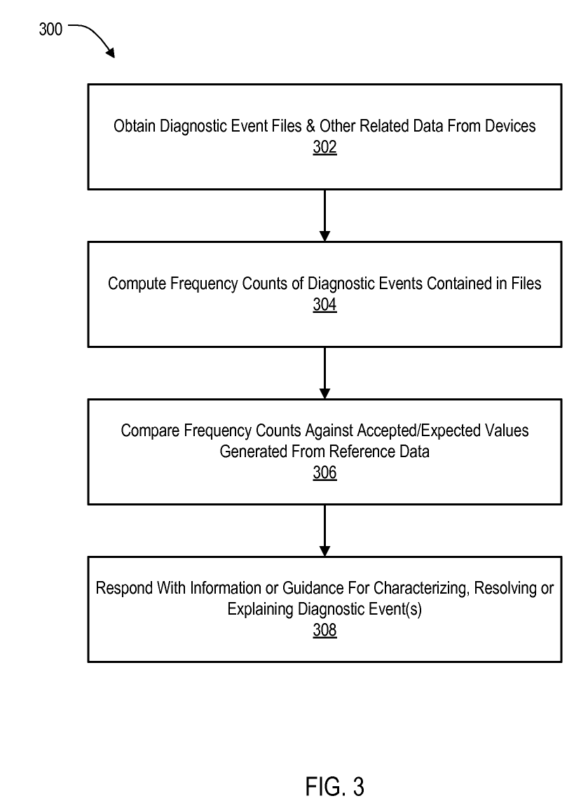

FIG. 3 is a flow diagram of example process 300 for analyzing diagnostic events and providing information or guidance to users or service center personnel based on a result of the analysis. In some implementations, process 300 can begin by obtaining diagnostic event files from devices (302). The event files can include historical information related to diagnostic events occurring on the device over a time span or, optionally, additional data related to the diagnostic events. Some examples of diagnostic events include but are not limited to: time since last restore, application crashes, kernel panics, unclean device resets, low-memory application aborts, modem resets, call failures, dropped calls, battery performance, thermal performance, awake time since last charged, sleep time since last charged, and any other event that can result in a failure of a device or degradation of device performance. Some examples of additional data include but are not limited to: configuration of the device, including versions of installed software and firmware or hardware model details; time and location of submitted information; information identifying the service personnel involved; reason(s) for the diagnostic submission; and any other relevant data related to the device, the diagnostic events, or the submission of those events.

In some implementations, for each file, frequencies of diagnostic events can be computed (304). The frequency counts can be compared against accepted and/or expected values generated from reference data (306). Reference data can be associated with a set of devices having at least one attribute (e.g., the same model number, same factory, device configuration) of the device being diagnosed. Reference data can include field data, trend data, other diagnostic events from that device, or any other data that can be compared with the diagnostic event data to determine possible causes of diagnostic events on a device. Information or guidance (e.g., pre-defined guidance) can be generated or selected based on a result of the comparison, and sent to the device or a host device (308) where it can be used to characterize, resolve or explain diagnostic event(s) or other technical issues.

In some implementations, results of the comparison can be used to categorize diagnostic events into one or more response categories or “buckets.” Some example categories include but are not limited to: No Problems Found, Device was Recently Restored, Device Software is Out of Date, High Frequency of Application Crashes, High Low-Memory Failures, High Frequency of Modem Logs, Unsupported Applications Installed, High Panic Count, High Unclean Shutdown Count and Never Been Fully Charged. Some of these response buckets are relevant to a use scenario where software diagnostic events are analyzed for a mobile phone, such as Apple Inc.'s iPhone®. In this use scenario, information or guidance is sent as a text response to service personnel in service centers, such as “Genius Bar” staff who can use the text to characterize, resolve or explain diagnostic event(s) or other technical issues. In other use scenarios, images, graphics, animations or any other desired communication format can be sent as information or guidance in lieu of, or in addition to text.

### Response Bucket: No problems Found

If this response bucket is triggered, no other buckets will be used. While the device may have captured some diagnostic events, none of the events are so frequent or so severe as to warrant an action on the part of the user or service personnel. The device is performing to specification insofar as the analysis performed by the remote diagnostic service can determine. Criteria for this response bucket can be that no other buckets are triggered. An example of information or guidance can be a text response stating: “Diagnostic logging on this device is active and working; however, the events recorded do no indicate any problems with this device.” Some example suggested steps for resolving the issue can be: 1) run other relevant diagnostics, 2) continue to discuss the issue(s) noted by the customer, and 3) document issues where relevant.

### Response Bucket: Device Software is Out of Date

Whatever problems the customer is experiencing, an upgrade will likely mitigate the problems. Other analysis may still be performed, and issues may be reported found because the customer might refuse to upgrade. Criteria for this response bucket can be that the operating system (OS) version of the device has a version number prior to a service-provided “current” version. An example of information or guidance can be a text response stating: “A more recent version of the iPhone software is available and should be installed. Important bug fixes are provided in each new release, so upgrading should improve the quality of the customer's experience.” An example suggested step for resolving the issue can be to upgrade the user's device.

### Response Bucket: High Frequency of Low Memory Crashes

The customer may be unhappy with the perceived stability of the device's applications, even though the sudden application aborts are due to the device running out of memory. Criteria for this response bucket can be either a) wired memory amount has been recorded above x MB or b) low memory crashes exceed other crash reports. If low memory crashes out number other crashes, then a majority of the time an application quits, changing the way the device is used may reduce the diagnostic events. In the case that the wired memory amount is high, and the customer experience may continue to degrade until the device is rebooted. An example of information or guidance can be a text response stating: “The application <list application> has aborted more often than expected. The most common cause for this is the device is running low on application memory. This may not mean there is too much data stored on the device; it simply means the device may be running too many memory-intensive tasks.” An example suggested step for resolving the issue can be to: 1) reboot the customer's device, and 2) give the customer simple steps for reducing application memory requirements.

The response buckets described above are only examples for a particular use scenario. Any suitable response can be provided as information or guidance to a user or service personnel and such information or guidance can be tailored to the device. The response buckets can be continuously and/or automatically updated as more diagnostic event files are analyzed and statistics and other criteria change accordingly.

### Example Device Architecture

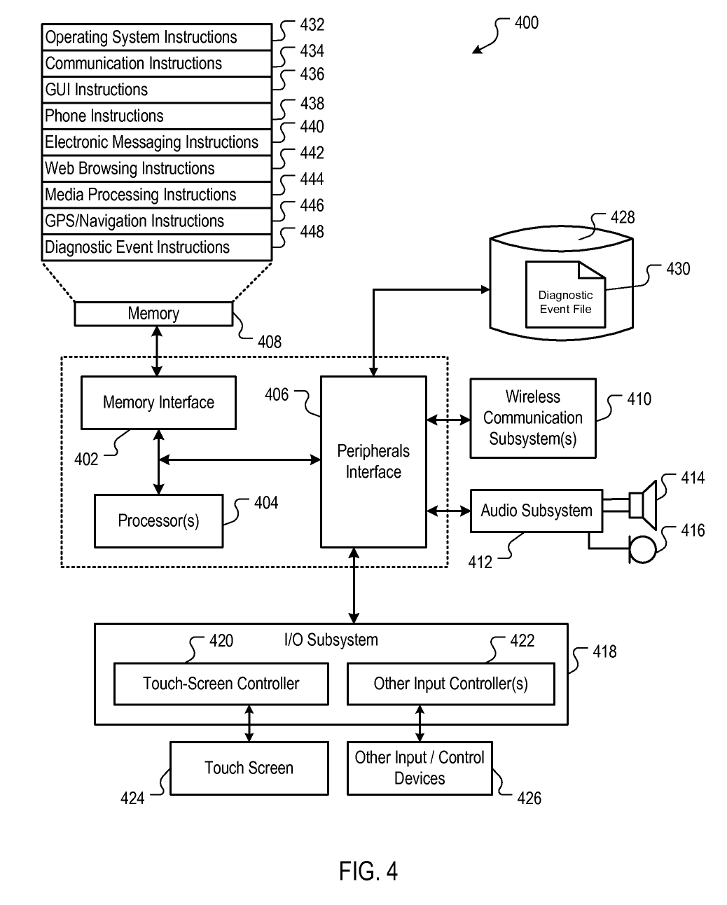

FIG. 4 is a schematic diagram of example device 400 for collecting diagnostic event files for use in the diagnostic system 100 of FIG. 1. The device 400 can include memory interface 402, one or more processors, image processors 404, and peripherals interface 406. Memory interface 402, one or more processors 404 and/or the peripherals interface 406 can be separate components or can be integrated in one or more integrated circuits. The various components in device 400 can be coupled by one or more communication buses or signal lines.

Sensors, devices and subsystems can be coupled to peripherals interface 406 to facilitate multiple functionalities. For example, storage device 428 can be coupled to peripherals interface 406 for storing diagnostic event files 430, as described in reference to FIGS. 1-3. Communication functions can be facilitated through one or more wireless communication subsystems 410, which can include radio frequency receivers and transmitters and/or optical (e.g., infrared) receivers and transmitters. The specific design and implementation of communication subsystem 410 can depend on the communication network(s) over which device 400 is intended to operate. For example, device 400 may include communication subsystems 410 designed to operate over a GSM network, a GPRS network, an EDGE network, a Wi-Fi or WiMax network, and a Bluetooth™ network. In particular, wireless communication subsystems 410 may include hosting protocols such that device architecture 400 may be configured as a base station for other wireless devices.

Audio subsystem 412 can be coupled to speaker 414 and microphone 416 to facilitate voice-enabled functions, such as voice recognition, voice replication, digital recording, and telephony functions.

I/O subsystem 418 can include touch screen controller 420 and/or other input controller(s) 422. Touch-screen controller 420 can be coupled to touch screen 424. Touch screen 424 and touch screen controller 420 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 424.

Input controller(s) 422 can be coupled to other input/control devices 426, such as one or more buttons, rocker switches, thumb-wheel, infrared port, USB port, and/or a pointer device such as a stylus. The one or more buttons (not shown) can include an up/down button for volume control of speaker 414 and/or microphone 416.

In one implementation, a pressing of the button for a first duration may disengage a lock of touch screen 424; and a pressing of the button for a second duration that is longer than the first duration may turn power to device 400 on or off. The user may be able to customize a functionality of one or more of the buttons. Touch screen 424 can, for example, also be used to implement virtual or soft buttons and/or a keypad or keyboard.

In some implementations, device 400 can present recorded audio and/or video files, such as MP3, AAC, and MPEG files. In some implementations, device architecture 400 can include the functionality of an MP3 player, such as an iPod Touch™. Device 400, therefore, may include a pin connector that is compatible with the iPhone® or iPod Touch™. Other input/output and control devices can also be used.

Memory interface 402 can be coupled to memory 408. Memory 408 can include high-speed random access memory and/or non-volatile memory, such as one or more magnetic disk storage devices, one or more optical storage devices, and/or flash memory (e.g., NAND, NOR). Memory 408 can store operating system 432, such as Darwin, RTXC, LINUX, UNIX, OS X, WINDOWS, or an embedded operating system such as VxWorks. Operating system 432 may include instructions for handling basic system services and for performing hardware dependent tasks. In some implementations, operating system 432 can be a kernel (e.g., UNIX kernel).

Memory 408 may also store communication instructions 434 to facilitate communicating with one or more additional devices, one or more computers and/or one or more servers. Memory 408 may include graphical user interface instructions 436 to facilitate graphic user interface processing; phone instructions 438 to facilitate telephony processes and functions; electronic messaging instructions 440 to facilitate electronic-messaging related processes and functions; web browsing instructions 442 to facilitate web browsing-related processes and functions; media processing instructions 444 to facilitate media processing-related processes and functions; GPS/Navigation instructions 446 to facilitate GPS and navigation-related processes and instructions; and diagnostic event instructions to facilitate processes and functions, as described in reference to FIGS. 1-3.

Each of the above identified instructions and applications can correspond to a set of instructions for performing one or more functions described above. These instructions need not be implemented as separate software programs, procedures or modules. Memory 408 can include additional instructions or fewer instructions. Furthermore, various functions of device 400 may be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining diagnostic event data and data related to the diagnostic event data or submission thereof from a device;
analyzing the diagnostic event data and related data;
determining one or more possible triggers for the diagnostic events based on results of the analysis; and
determining information or guidance for characterizing, resolving or explaining the diagnostic events.

2. The method of claim 1, further comprising:
receiving the diagnostic event data and additional data related to the diagnostic event data or submission thereof from a host device coupled to the device;
comparing the diagnostic event data with reference data associated with a set of devices having at least one attribute of the device; and
sending the information or guidance to the host device.

3. The method of claim 1, wherein the diagnostic event data spans a period of time.

4. The method of claim 2, where comparing the diagnostic event data with reference data, further comprises:
comparing frequency of occurrence for a diagnostic event with one or more reference values based on field or trend data for the set of devices or other comparisons to relevant data and
identifying pre-defined information or guidance based on a result of the comparisons.

5. The method of claim 1, further comprising:
updating the reference data based on the diagnostic event data obtained from the device.

6. The method of claim 5, where the updating is continuous or automatic.

7. A system comprising:
a device operable for collecting diagnostic event data; and
a diagnostic service operable for obtaining the diagnostic event data and related data from the device or a device submitting on its behalf over a network, for analyzing the diagnostic event data using reference data associated with a set of devices having at least one attribute of the device, and for generating information or guidance for characterizing, resolving or providing explanation regarding the diagnostic event.

8. The system of claim 7, further comprising:
a host device coupled to the device and operable for obtaining the diagnostic event data from the device, establishing a connection with the diagnostic service, sending the diagnostic event data to the diagnostic service, and receiving the information or guidance from the diagnostic service.

9. The system of claim 7, where the diagnostic event data includes one or more of the following diagnostic event data: time since last restore, application crashes, kernel panics, unclean device resets, low-memory application aborts, modem resets, call failures, dropped calls, battery performance, thermal performance, awake time since last charged and sleep time since last charged.

10. A mobile device comprising:
a processor;
a computer-readable medium coupled to the processor and having instructions stored thereon, which, when executed by the processor causes the processor to perform operations comprising:
recording diagnostic event data, where the diagnostic event data includes a telephony related failure; and
sending the diagnostic event data to another device in response to a request for diagnostic event data.

11. The device of claim 10, where the mobile device is a smart phone or media player.

12. The device of claim 10, where the mobile device includes a touch sensitive display.
